(19) United States
(12) Patent Application Publication
(10) Pub. No.: US 2011/0295677 A1
(43) Pub. Date: Dec. 1, 2011

(54) EVENT-BASED AD TARGETING

(75) Inventors: PRASHANT DHINGRA, Redmond, WA (US); RAZA UL-MUSTAFA, Bellevue, WA (US)

(73) Assignee: MICROSOFT CORPORATION, Redmond, WA (US)

(21) Appl. No.: 12/788,566

(22) Filed: May 27, 2010

(51) Int. Cl. G06Q 30/00; G06Q 10/00

(52) U.S. Cl. 705/14.42; 705/14.52; 705/14.53; 705/14.58

(57) ABSTRACT

Embodiments of the present invention enable an advertiser to target ads to users based on occurrences of events that may influence the purchasing behavior of the users. The advertiser may specify an event to be used in targeting an ad. The event's region of influence is determined, and ads are targeted to users that are located within the region of influence.

### BACKGROUND

Online advertising is a significant aspect of computing environments, as it presents a powerful way for advertisers to market their products and services. Consumer needs, interests, and buying patterns are impacted by many factors. Online advertising enables advertisers to target their ads to consumers based on a number of those factors, such as location, day of the week, time of the day and consumer demographics. For example, an advertiser may specify “show this ad on Sundays to consumers living in Seattle.” Targeting ads in this manner allows advertisers to optimize the effectiveness of their advertising campaigns.

Additionally, there are a variety of advertisement systems and methods for delivering online advertisements for presentation to users. Generally, online advertising includes any form of advertising that uses computer network environments to deliver advertisements and other marketing messages to potential customers. For instance, advertisements may be presented within web pages, search engine search results, online video games, advertisement-based software applications, and email messages, to name a few. A wide variety of additional approaches and environments exist for delivering online advertising for presentation to users.

Currently, electronic advertisements may range from simple text-based advertisements to rich media advertisements, which are capable of numerous features including playing sound and/or video, expanding, and animation.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed-description section below. This summary is not intended to identify key features or essential features of the claimed subject matter, nor is it intended to be used as an aid in isolation to determine the scope of the claimed subject matter.

Embodiments of the present invention are generally directed to providing event-based targeting of ads, where an event creates a type of climate that influences purchasing behavior of network users. A location of an event is determined, and a regional scope of influence of the event is identified based on user queries that are related to the event. A user located within the regional scope of influence is identified, and an ad that is associated with the event is selected and presented to the user.

### BRIEF DESCRIPTION OF THE DRAWINGS

Illustrative embodiments of the present invention are described in detail below with reference to the attached drawing figures, and wherein:

FIG. 1 is a block diagram of a computing environment suitable for use in implementing embodiments of the present invention;

FIG. 2 is a block diagram of an exemplary system in which embodiments of the invention may be employed;

FIG. 3 depicts a method for using advertiser bids with event-based ad targeting in accordance with an embodiment of the present invention;

FIG. 4 depicts an interface for receiving advertiser event criteria for event-based ad targeting in accordance with an embodiment of the present invention;

FIG. 5 depicts a method for receiving an advertiser's event-based criteria for event-based ad targeting in accordance with an embodiment of the present invention;

FIG. 6 depicts a geographical region for use in event-based ad targeting in accordance with an embodiment of the present invention; and

FIG. 7 depicts a method for targeting an ad to a user that is within a region of influence of an event in accordance with an embodiment of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the present invention may be, among other things: a method, system, or set of instructions embodied on one or more computer-readable media. Computer-readable media include both volatile and nonvolatile media, removable and nonremovable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

Embodiments of the present invention provide targeted delivery of ads to users. In accordance with embodiments of the present invention, an advertiser may submit an advertisement to an advertisement delivery system that facilitates delivery of advertisements within electronic environments. The electronic environments in which advertisements may be delivered include, for instance, search results, web pages, online games, advertisement-supported software applications, and emails.

When the advertiser submits an advertisement, the advertiser may submit additional information for the advertisement and/or select from a variety of options. Such options typically include targeting criteria such as location of the consumer, day of the week, time of day, user demographics, a user's online activities, and user preferences. In accordance with embodiments of the present invention, the advertiser may specify whether the submitted advertisement is to be associated with occurrences of specific events or types of events that generate a climate that may influence the purchasing behavior of potential consumers.

For example, an advertiser may specify “show this ad to consumers in cities during the occurrence of a football game.” Alternately, the advertiser may specify events or types of events without associating them with specific advertisements. In that case, the advertisement delivery system may use one or more algorithms to determine which ads to associate with an event. For example, if the advertiser sells sports memorabilia and selects football games as the type of event, the ad delivery system may associate the advertiser's football-related ads with football games. In other embodiments, the advertiser may specify ads without selecting associated events. In that case, the advertisement delivery system may determine algorithmically to associate football-related ads with football games and baseball-related ads with baseball games.

Types of climate may include political climate and economical climate. In one embodiment, an advertiser may specify one or more of the following:

a) show this ad in countries where stock market has 2% growth in last 1 month;

b) show this ad (security alarms) in cities where burglary rates are high;

c) show this ad in cities in which high number of sports injuries are reported;

d) show this ad in cities in which sports tournament, events are happening; and

e) show this ad in cities which are having kite fairs.

An event, type of event, or climate may include multiple occurrences of an event, e.g., high burglary rates are based on multiple occurrences of burglaries. An event or event type may also include a condition, such as 2% stock market growth.

Many factors, such as the date, location, and region of influence of the event may determine whether an ad is delivered to a particular consumer. It is contemplated that embodiments of the invention may incorporate a number of factors in order to determine how ads are targeted based on occurrences of events.

When the advertisement delivery system receives a request for advertisements, such as from a web page that is being accessed by a user, one or more advertisements are selected for delivery. In embodiments of the invention, the advertisement delivery system determines whether the user is potentially influenced by the occurrence of an event as specified by the advertiser. This may involve determining a region or scope of influence that surrounds, or extends beyond, the geographical location of the event. For example, if the advertiser specifies “state fair” as an event criterion, then the advertisement delivery system may use a predetermined radius of 200 miles for state fairs, which assumes that consumers within a radius of 200 miles of a state fair are affected with regard to their purchasing behaviors. Or, the region of influence may be determined based on dynamic factors, such as users' online queries that are related to a particular state fair. It is contemplated that other means of determining the region or scope of influence of an event may be used in embodiments of the invention.

Embodiments of the invention may use bid boosting, based on the occurrences of events, to determine the charge to an advertiser when an ad is presented to users. For example, an advertiser may bid $0.25 per thousand deliveries of an ad to a general audience, and $0.50 per thousand deliveries of an ad to an audience associated with a specific event. In this case, the advertisement system may attempt to maximize ad delivery to users within the region of influence of a specified event in order to maximize ad revenue.

Additionally, embodiments of the invention may compare bids of one advertiser with another, with respect to an occurrence of an event, in order to determine which advertiser's ad to deliver in order to maximize ad revenue. For example, Advertiser A may bid $0.25 per thousand deliveries of an ad to a general audience, and $1.00 per thousand deliveries of an ad to an audience within a state fair's region of influence. Advertiser B may bid $0.50 per thousand deliveries to a general audience and $0.75 per thousand deliveries to an audience within the fair's region of influence. In this case, when an ad is to be delivered to a user outside the fair's region of influence, Advertiser B's ad may be selected because Advertiser B's bid for delivery to a general audience is higher. On the other hand, when an ad is to be delivered to a user within the fair's region of influence, Advertiser A's ad may be selected because Advertiser A's bid for delivery to an audience within the region of influence is higher that Advertiser B's bid.

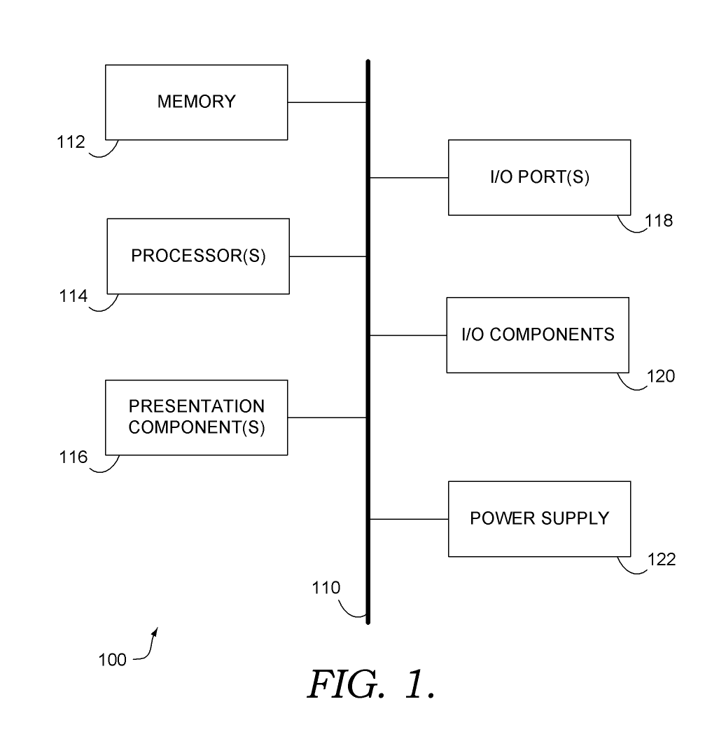

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

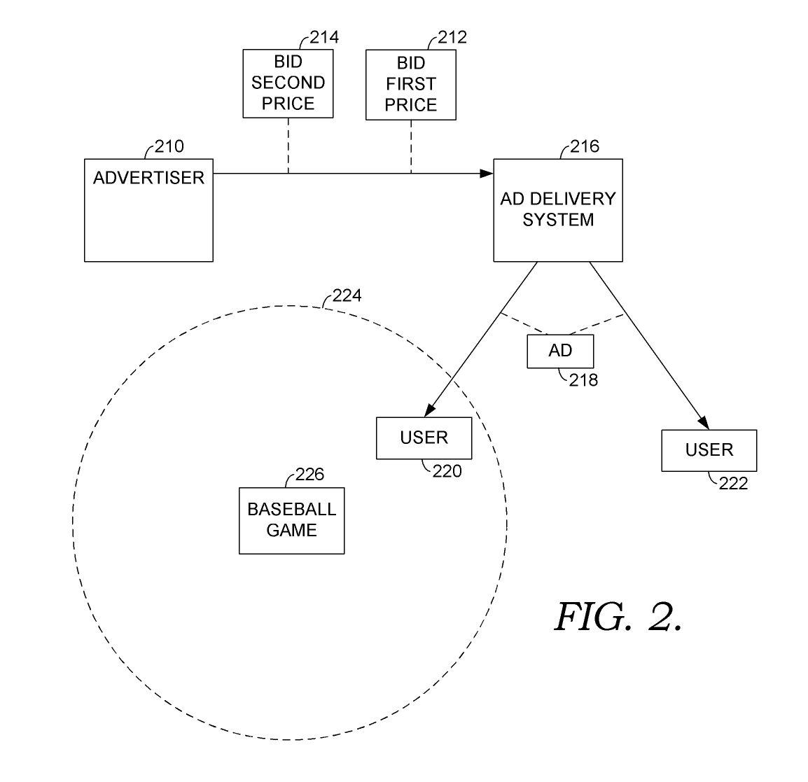

Referring now to FIG. 2, an environment for targeting ads is depicted in accordance with an embodiment of the present invention and is generally designated as environment 200. Environment 200 is but one example of a suitable environment and is not intended to suggest any limitation as to the scope of use or functionality of the invention. Neither should environment 200 be interpreted as having any dependency or requirement relating to any one or combination of components illustrated.

An advertiser 210 may wish to target advertisements to network users that are more likely to respond to the ads than a general audience would be. Advertiser 210 may be a manufacturer, a reseller, a service provider, or any type of entity that advertises products, services, or information by means of a network.

Advertiser 210 provides bids 212 and 214 to an ad delivery system 216, and also specifies criteria to be used by ad delivery system 216 in deciding which users an ad 218 is to be presented to. Bids 212 and 214 offer different prices for different conditions in which an ad is presented, and may be related to the criteria specified by advertiser 210.

Ad delivery system 216 receives bids from advertisers and makes decisions about which ads to present to which users, based on bid prices and other criteria. Ad delivery system 216 may be a server or other type of computing device, or may include a number of servers and/or computing devices. It is contemplated that ad delivery system 216 may exclusively perform ad delivery functions, or may perform additional functions as well.

Ad 218 is potentially presented to either or both of users 220 and 222. Users 220 and 222 may access the network via desktop computers, laptops, mobile phones, PDAs, or any device that is network enabled. Users 220 and 222 may or may not be associated with the criteria specified by advertiser 210.

User 220 is located within a proximity 224 to an event (baseball game) 226. User 222 is located outside of proximity 224. Event 226 is an event that potentially influences how a user may respond to an ad. Proximity 224 represents a region or scope of influence within which users may be affected by event 226.

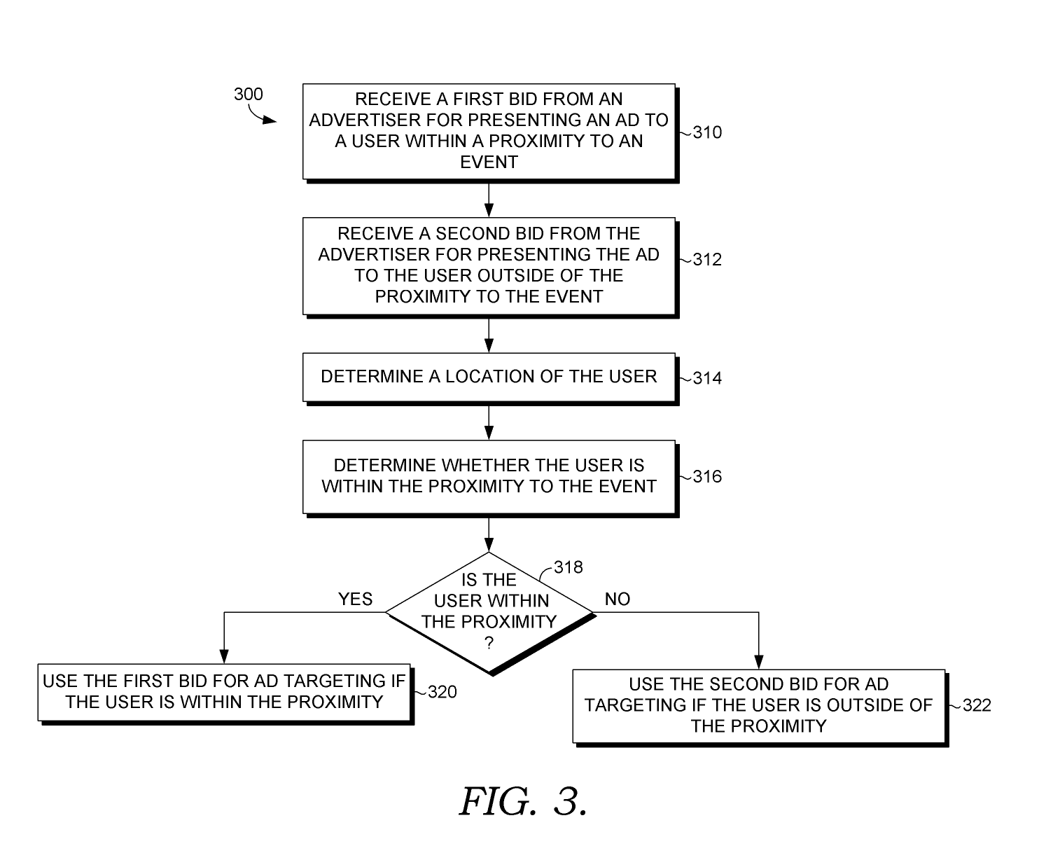

Referring now to FIG. 3, a method for targeting ads is depicted in accordance with an embodiment of the present invention and is generally designated as method 300. Method 300 is but one example of a suitable method and is not intended to suggest any limitation as to the scope of use or functionality of the invention. Neither should method 300 be interpreted as having any dependency or requirement relating to any one or combination of components illustrated.

FIG. 3 is described with reference to FIG. 2. Continuing with FIG. 3, at a step 310, a first bid 212 is received by ad delivery system 216 from advertiser 210. Bid 212 includes a bid price that advertiser 210 is willing to pay when ad 218 is presented to a user that is within a proximity 224, or scope of influence, of a particular event, such as event 226. For example, advertiser 210 may be a reseller of sports memorabilia and event 226 may be baseball game 226 located in a city. It may be determined that network users living within the city are influenced by the presence of baseball game 226, such that they are more likely to buy sports memorabilia. In that case, proximity 224 may extend to the city limits. Alternately, it may be determined that the scope of influence of baseball game 226 extends over a larger region, in which case proximity 224 would include the larger region. Various means may be used to determine the scope of influence of an event, for example, demographics of the users that live in the region surrounding the event, online activities of users in the region or beyond, and statistical analysis, to name only a few. The scope of influence may also be a predetermined, fixed region. In embodiments of the invention, ad delivery system 216 may maintain or at least access a database of event locations and/or associated regions of influence.

At a step 312, a second bid 214 is received from advertiser 210. Bid 214 includes a price that advertiser 210 is willing to pay when ad 218 is presented to a user that is not within the scope of influence of baseball game 226. Bid 214 is typically less than bid 212, because a user outside of the scope of influence of baseball game 226 may be less likely to purchase sports memorabilia in response to ad 218.

At a step 314, a location of a user is determined, for example, the location of user 220. At a step 316, based on the location of user 220, it is determined that user 220 is located within proximity 224.

At a step 318, it is determined whether a user is located within proximity 224. In the case of user 220, it is determined that user 220 is located within proximity 224 and, at a step 320, the first bid 212 is used for ad targeting with regard to ad 218. In an embodiment of the invention, ad delivery system 216 presents ad 218 to user 220 and charges the price associated with bid 212 to advertiser 210.

At step 318, in the case of user 222, it is determined that user 222 is not located within proximity 224 and, at a step 322, the second bid 214 is used for ad targeting. Ad delivery system presents ad 218 to user 222 and charges the price associated with bid 214 to advertiser 210.

Other, more complex, scenarios are also contemplated. For example, it may be that bids are received from more than one advertiser. If a second advertiser submits bids, when ad delivery system 216 determines that user 220 is within proximity 224 it may use advertiser 210's first bid 212 for ad targeting by comparing bid 212 with the second advertiser's bid and select the ad that has the higher bid. In the event that ad delivery system 216 determines that user 222 is outside of proximity 224, then it would compare advertiser 210's second bid 214 with the second advertiser's bid.

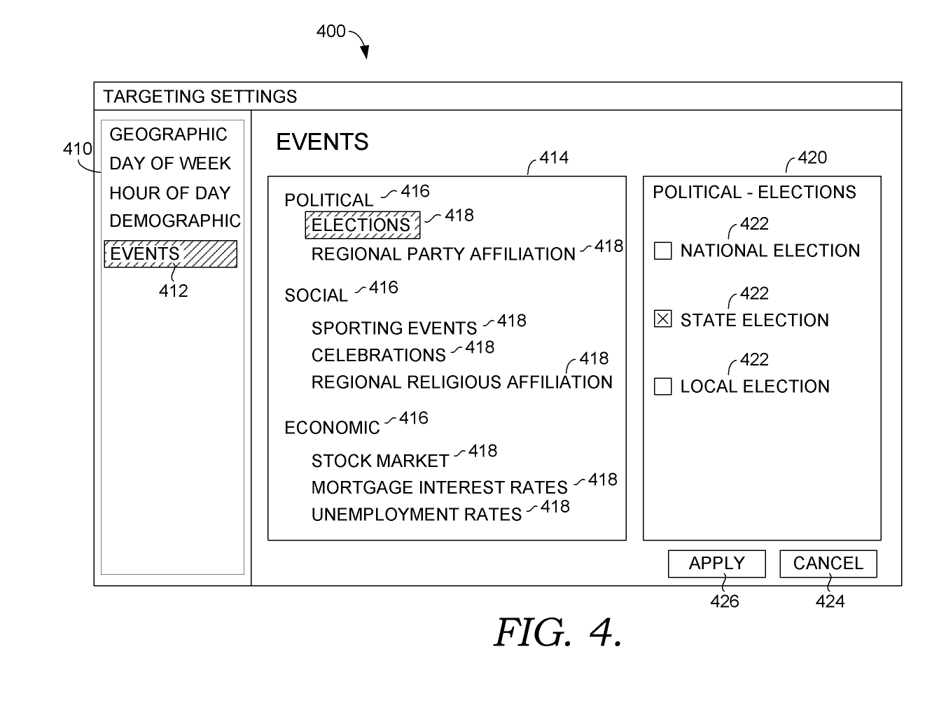

Referring now to FIG. 4, an interface for targeting ads is depicted in accordance with an embodiment of the present invention and is generally designated as interface 400. Interface 400 is but one example of a suitable interface and is not intended to suggest any limitation as to the scope of use or functionality of the invention. Neither should interface 400 be interpreted as having any dependency or requirement relating to any one or combination of components illustrated.

Continuing with FIG. 4, a targeting menu 410 includes general targeting categories with events category 412 selected. A target category window 414 displays event categories 416. Within each event category 416 are general targeting events 418 with general event elections 418 selected. Targeting event window 420 displays specific event-based criteria 422, with “national election” selected. Targeting menu 410 is used by an advertiser to specify event criteria to be used for event-based targeting of ads.

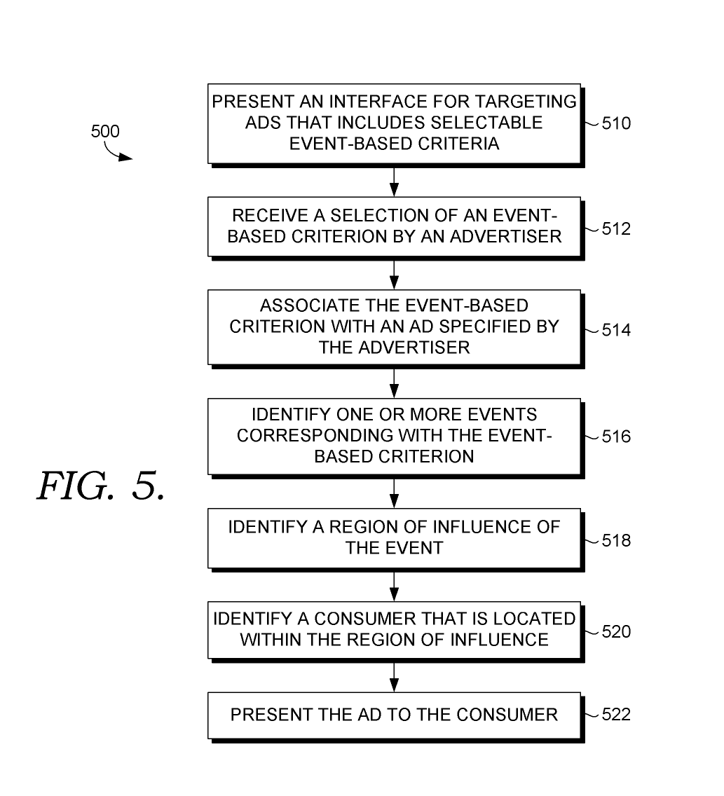

Referring now to FIG. 5, a method for receiving an advertiser's event-based criteria for event-based ad targeting is depicted in accordance with an embodiment of the present invention and is generally designated as method 500. Method 500 is but one example of a suitable method and is not intended to suggest any limitation as to the scope of use or functionality of the invention. Neither should method 500 be interpreted as having any dependency or requirement relating to any one or combination of components illustrated.

FIG. 5 is described with reference to FIG. 2 and FIG. 4. Continuing with FIG. 5, at a step 510, an interface 400 is presented for targeting ads. In embodiments of the invention interface 400 facilitates communication of an advertiser's ad-targeting preferences to ad delivery system 216. Interface 400 may take other forms than what is depicted in FIG. 4.

In an embodiment of the invention, an advertiser may select events category 412 from targeting menu 410. As depicted in FIG. 4, events category 412 is highlighted to indicate that it has been selected by a user. Once events category 412 is selected, target category window 414 displays event categories 416, such as political, social and economic. Associated with each event category 416 are general targeting events 418 such as elections, regional party affiliation, and sporting events, as depicted in FIG. 4. The advertiser may select one of the general targeting events, such as elections 418. Event-criteria window 420 displays specific event-based criteria 422 associated with the selected general targeting event 418. Event-based criteria include events and situations that potentially influence consumer purchasing behavior. As depicted in FIG. 4, event-criteria window displays national election, state election and local election. The advertiser may select one or more of event-based criteria 422. As depicted, “state election” is selected. A cancel button 424 cancels the event-based criteria selection, and an apply button 426 applies the selection to be used in targeting one or more ads.

Continuing with FIG. 5, at a step 512 the selected criterion of “state election” is received by ad delivery system 216 when apply button 426 is selected. In an embodiment of the invention, interface 400 may be considered as part of ad delivery system 216, so in that case it would be more appropriate to state that the selection of “state election” is received by a part or aspect of ad delivery system 216.

At a step 514, an ad specified by the advertiser is associated with the event-based criterion 422 (i.e., “state election”). Examples of ads an advertiser may associate with a state election include campaign ads and ads for political magazines and publications. Ad delivery system may include a database of ads received from an advertiser, or ad delivery system may access a database of ads maintained by the advertiser or other entity. Although FIGS. 4 and 5 illustrate an embodiment in which the advertiser may specify which ads are related to specific event-based criteria, in other embodiments ad delivery system may determine algorithmically which event-based criteria an ad would be associated with based on information contained within the ad or by other means.

At a step 516, ad delivery system 216 identifies an event that corresponds with the selected event-based criterion. For example, an election for Missouri state representatives might be identified

At a step 518, ad delivery system 216 determines a region of influence of the identified event. For example, the region of influence of “state election,” e.g. the election for Missouri state representatives, may be determined to extend throughout the entire state of Missouri based on the fact that it is a statewide election. Likewise, if the selected event-based criterion 422 is “local election,” then for a city election the region of influence might be determined to extend throughout the city limits based on the fact that it is a city election. Embodiments of the invention may use any means of determining the scope of influence, including the nature of the event, user queries, user web browsing and historical sales records.

At a step 520, ad delivery system 216 identifies a potential consumer that is located within the region of influence of event-based criterion 422 (i.e., “state election”). In the case of a state election, a potential consumer may be any online user that is registered to vote in the state. Depending on the nature of the event-based criterion, potential consumers within the region of influence may be determined by any number of means, for example, based on the home addresses associated with online accounts.

At a step 522, the ad is presented to the potential consumer that was identified in step 520. The ad may be presented in a number of ways, for example, on a web page that the user is viewing, at the beginning of an online video that the user selects, in an email sent to a user, a text message sent to a mobile phone, or any other means of delivering an ad over a network.

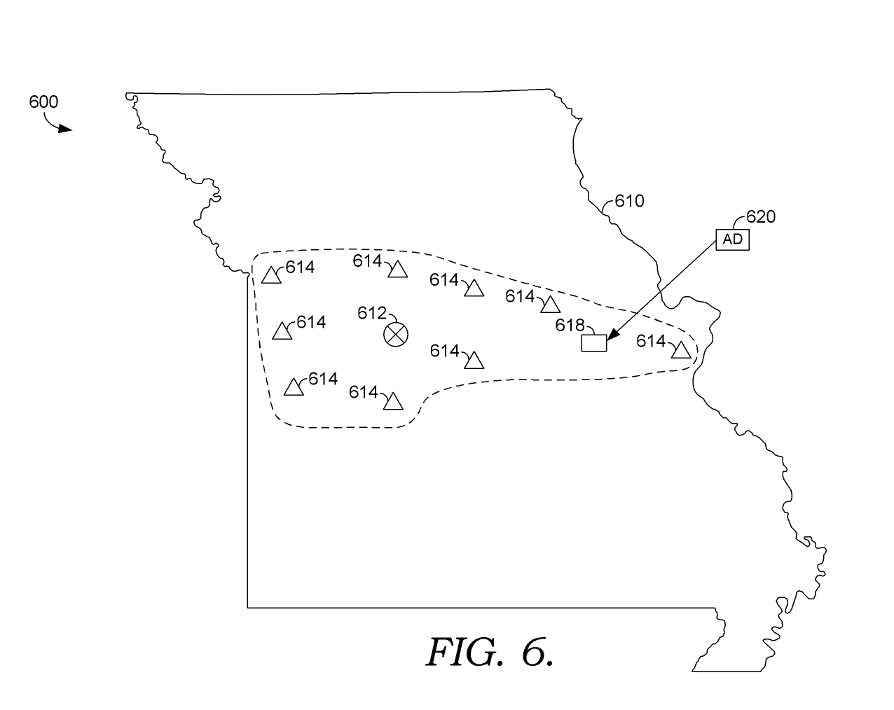

Referring now to FIG. 6, a geographical region in accordance with an embodiment of the present invention is depicted and is generally designated as geographical region 600. Geographical region 600 is but one example of a suitable geographical area and is not intended to suggest any limitation as to the scope of use or functionality of the invention. Neither should geographical region 600 be interpreted as having any dependency or requirement relating to any one or combination of components illustrated.

Continuing with FIG. 6, a geographical representation of a state 610 is depicted. Also depicted are a state fair 612, user queries 614, a region of influence 616, a user 618, and an ad 620.

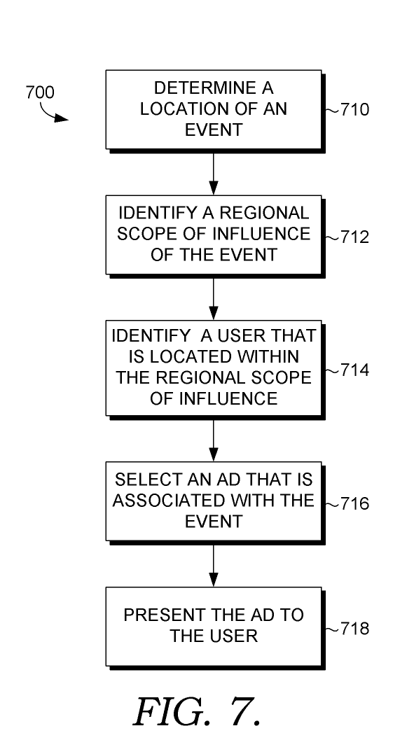

Referring now to FIG. 7, a method in accordance with an embodiment of the present invention is depicted and is generally designated as method 700. Method 700 is but one example of a suitable method and is not intended to suggest any limitation as to the scope of use or functionality of the invention. Neither should method 700 be interpreted as having any dependency or requirement relating to any one or combination of components illustrated.

FIG. 7 is described with reference to FIG. 2 and FIG. 6. Continuing with FIG. 7, at a step 710, the location of state fair 612 is determined by ad delivery system 216. Ad delivery system 216 may maintain and/or access a database that includes various types of events and their respective locations.

At a step 712, the regional scope of influence 616 of state fair 612 is determined. In the present embodiment, the determination is made based on user queries 614 that are related to state fair 612. For example, network users that are interested in attending state fair 612 may perform queries about events occurring at the fair, the dates of the fair, and the location of the fair. User queries 614 may also include browsing web pages that are related to state fair 612, online purchases of tickets to state fair 612, and other online activities that are related to state fair 612. Various factors related to user queries 614 may be used to determine regional scope of influence 616, such as location, density of queries in different locations, and frequency of queries. Other factors may be used as well. Regional scope of influence 616 may be a single contiguous region, or may include multiple regions that do not overlap.

At a step 714, user 618 is identified and determined to be within regional scope of influence 616. The location of user 618 may be determined based on home addresses associated with online accounts, locations of users' devices, such as cell phones, based on GPS or cell tower locations, or any other means. User 618 may or may not be one of the users that performed user queries 614.

At a step 716, ad 620 is selected as an ad that is associated with state fair 612. Ad 620 may directly relate to state fair 612, such as an ad intended to promote fair attendance, or it may be related to goods or services indirectly related to state fair 612. Examples include promotions for Amtrak tickets to the fair location and motels near the fairgrounds.

At a step 718, ad 620 is presented to user 618. Various means of presenting ad 620 may be used. Text messages, web browser banner ads, rich media ads, and emails are but a few examples of how ad 620 may be presented to user 618.

Many different arrangements of the various components depicted, as well as components not shown, are possible without departing from the scope of the claims below. Embodiments have been described with the intent to be illustrative rather than restrictive. Alternative embodiments will become apparent readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. One or more computer storage media having computer-executable instructions embodied thereon that, when executed, perform a method of targeting ads, the method comprising:
receiving a first bid from a first advertiser for presenting a first ad to a user based on events external to the user, wherein the events include situations that potentially influence user purchases, and wherein the first bid includes a first price for the first ad when the first ad is presented to the user within a proximity to an event;
receiving a second bid from the first advertiser for presenting the first ad to the user, wherein the second bid includes a second price for the first ad when the first ad is presented to the user outside of the proximity to the event;
determining a location of the user;
based on the location of the user, determining whether the user is within the proximity to the event;
using the first bid for ad targeting purposes if the user is within the proximity to the event; and
using the second bid for ad targeting purposes if the user is outside of the proximity to the event.

2. The media of claim 1, the method further comprising presenting the first ad to the user and charging the first advertiser with the first price when the user is within the proximity to the event.

3. The media of claim 1, the method further comprising presenting the first ad to the user and charging the first advertiser with the second price when the user is outside of the proximity to the event.

4. The media of claim 1, the method further comprising comparing the first bid or the second bid with a third bid from a second advertiser, wherein the third bid is associated with a second ad, wherein the first ad or the second ad is presented to the user based on a result of the comparing.

5. The media of claim 1, wherein the first ad is designated by the first advertiser.

6. The media of claim 1, wherein the first ad is designated by an algorithm based at least in part on the event.

7. One or more computer storage media having computer-executable instructions embodied thereon that, when executed, perform a method of targeting ads, the method comprising:
providing an interface for targeting ads, wherein the interface includes selectable event-based criteria, and wherein event-based criteria include events and situations that potentially influence consumer behavior;
receiving a selection of an event-based criterion from an advertiser by way of the interface;
associating the event-based criterion with an ad specified by the advertiser;
identifying an event corresponding with the event-based criterion;
identifying a region of influence of the event;
identifying a potential consumer that is located within the region of influence; and
presenting the ad to the potential consumer.

8. The media of claim 7, wherein the ad is identified based on input from an advertiser that associates the ad with the event-based criterion.

9. The media of claim 7, wherein the ad is identified based on an algorithm that associates the ad with the event-based criterion.

10. The media of claim 7, wherein the region of influence is identified based on online activities of a plurality of network users.

11. The media of claim 7, wherein the region of influence is identified based on the event-based criterion.

12-13. (canceled)

14. The media of claim 7, wherein an event includes multiple occurrences of an event.

15. One or more computer storage media having computer-executable instructions embodied thereon that, when executed, perform a method of targeting ads, the method comprising:
determining a location of an event;
identifying a regional scope of influence of the event based on queries from a plurality of users, wherein the queries are related to the event;
identifying a user that is located within the regional scope of influence;
selecting an ad that is associated with the event; and
presenting the ad to the user.

16. The media of claim 15, wherein the ad is selected based on input from an advertiser that associates the ad with the event.

17. The media of claim 15, wherein the ad is selected based on an algorithm that associates the ad with the event.

18. The media of claim 15, the method further comprising determining a location of the user.

19. The media of claim 15, wherein identifying the user is based at least in part on the user's online activity.

20. The media of claim 15, wherein determining the location of the event includes accessing a database of event information.

21. The media of claim 7, wherein identifying the potential consumer is based at least in part on the potential consumer's online activity.

22. The media of claim 10, wherein the online activities include user queries that are related to the event.
